(19) United States
(12) Patent Application Publication
(10) Pub. No.: US 2003/0167231 A1
(43) Pub. Date: Sep. 4, 2003

(54) Method and system for processing credit card payments

(75) Inventors: Brad K. Winking, Omaha, NE (US); David J. DeLawter, Omaha, NE (US); John M. Patton, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/091,606

(22) Filed: Mar. 4, 2002

(51) Int. Cl. G06F 17/60

(52) U.S. Cl. 705/40

(57) ABSTRACT

A system for processing credit card payments is provided. According to one aspect of the system, a client is able to submit payment transactions in different formats for processing. Depending on the submission format, the payment transaction can be processed by either a batch process or a right-time process. The right-time process processes the payment transaction in real-time upon submission thereby allowing the corresponding credit account to be updated in a more timely manner. In particular, the right-time process adjusts the available credit relative to the corresponding credit account in a real-time manner so that the available credit closely tracks or reflects payments made to the credit account.

### CROSS REFERENCES TO RELATED APPLICATION(S)

The present application is related to U.S. Provisional Patent Application Serial No. [to be assigned], entitled “METHOD AND SYSTEM FOR PROCESSING CREDIT CARD RELATED TRANSACTIONS,” by Zelechoski et al., filed on Mar. 4, 2002; and U.S. patent application Ser. No. [to be assigned], entitled “METHOD AND SYSTEM FOR IMPROVING FRAUD PREVENTION IN CONNECTION WITH A NEWLY OPENED CREDIT ACCOUNT” by Britton et al., filed on Mar. 4, 2002, both of which are commonly assigned and owned, the disclosures of which are hereby incorporated by reference in its entirety as if fully set forth herein for all purposes.

### BACKGROUND OF THE INVENTION

The present invention generally relates to transactions involving credit cards. More specifically, the present invention relates to a computerized method and system for processing credit card payments.

The birth of a credit card generally begins with an applicant supplying information to complete a credit card application and apply for a credit account with an issuer or issuing bank. The issuer is usually a bank that issues the credit card and extends credit to the cardholder through the credit account linked to the credit card. Typically, the process of supplying the necessary information can be done electronically or by paper. The credit card application is then processed, and if approval criteria are met, a credit card is issued to the applicant who now becomes a cardholder. The process of issuing a credit card involves a number of steps including, for example, coding the credit card with cardholder data on the magnetic stripe and embossing the cardholder's name, account number and expiration date on the credit card.

When the credit card is first received by the cardholder, the cardholder needs to activate the credit card. Activation of the credit card is generally done by requiring the cardholder to call the issuer from his/her home phone. Once the credit card is activated, the cardholder may then use the credit card to make purchases or conduct transactions.

A typical credit card transaction involves a number of parties. In addition to the cardholder and the issuer, the parties involved in a credit card transaction include a merchant, an acquirer and a credit card association such as Visa or Mastercard. The acquirer is a business entity, e.g., a commercial bank, that has a business relationship with the merchant and handles credit card transactions from that merchant.

A typical credit card transaction involves the following steps. First, the merchant calculates the amount of the transaction or purchase and seeks payment from the cardholder. The cardholder then presents the merchant with his/her credit card. The merchant then runs the credit card through a point of sale terminal. The point of sale terminal captures credit card and sales information and sends such information together with an authorization request to the acquirer. The acquirer, in turn, processes the information received from the point of sale terminal and forwards any relevant information and the authorization request to the issuer. The issuer processes the relevant information and the authorization request to determine whether the transaction should be authorized. The issuer then sends an approval or denial code back to the acquirer. The acquirer relays the approval or denial code to the point of sale terminal for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. The remaining amount is then transferred by the acquirer to the merchant's account. The issuer also bills the cardholder for the transaction amount by sending the cardholder a credit card statement. The cardholder is typically billed by the issuer on a monthly cycle.

The foregoing is merely a general description of a typical credit card transaction. Variations and additional process(es) may be involved. It should also be understood that while certain parties, such as the issuer and the acquirer, are described above as performing certain functions, in typical situations, most or all of the functions to be performed by these parties may be performed on their behalf by third parties.

As described above, the cardholder typically receives a monthly credit card statement from the issuer detailing transactions which have been incurred in the previous month and the amount currently owed. Payment for the amount owed can be made by either check or online electronic fund transfer. The payment is then posted to the corresponding credit account. Under conventional practice, payment posted to a credit account does not have any immediate effect on that credit account. For example, the credit availability limit and the current amount owed do not accurately reflect the payment made until a later time. This is attributed to the fact that the payment processing is still being handled by computer systems which continue to utilize batch processing. FIG. 1 illustrates a general, conventional batch processing system which processes credit card payments. Payment information collected from online transactions 2 and batch files 4 are combined into a transaction file 6. The transaction file 6 is stored usually in the form of magnetic tapes. The batch processing system 8 then processes the transaction file 6 and generates various output files 10 which are then passed onto backend systems 12. The backend systems 12, in turn, make the appropriate adjustments to update the corresponding credit accounts.

Batch processing has proved to be inefficient and lacking in ability to provide real-time response or access. For example, since payment transactions are not processed in real-time, payments received for a credit account are generally not reflected until the transaction batch is run. The substantial latency between payment receipt and account update results in a number of disadvantages. For example, this latency may cause unnecessary inconvenience on the part of the cardholder. In one instance, despite having made a payment to his/her credit account, a cardholder may still risk having a transaction rejected since his/her credit account may not have been updated fast enough. In another instance, a collection agency may initiate collection procedures against a cardholder prematurely because the latest account information is not provided to the collection agency in a timely manner. Hence, it would be desirable to provide a computerized method and system which is capable of processing credit card payments in a more efficient manner.

### SUMMARY OF THE INVENTION

A method and system for processing credit card payments is provided. According to one exemplary aspect of the system, a client is able to submit payment transactions in different formats for processing. A payment transaction may relate to a payment made to a corresponding credit account or a reversal which need to be performed to retract a previously made payment which is erroneous. Depending on the submission format, the system can process the payment transaction by using either a batch process or a right-time process. The right-time process processes the payment transaction in real-time upon submission thereby allowing the corresponding credit account to be updated in a more timely manner. In particular, the right-time process adjusts the available credit relative to the corresponding credit account in a real-time manner so that the available credit closely tracks or reflects payments made to the credit account.

Optionally, information relating to the available credit is provided to customer service to allow customer service representatives to better service the account holder. Furthermore, information relating to the payment transaction can also be provided to collections to allow collections agency to better manage delinquent accounts and provide improved services.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating a general, conventional batch processing system which processes credit card payment; and

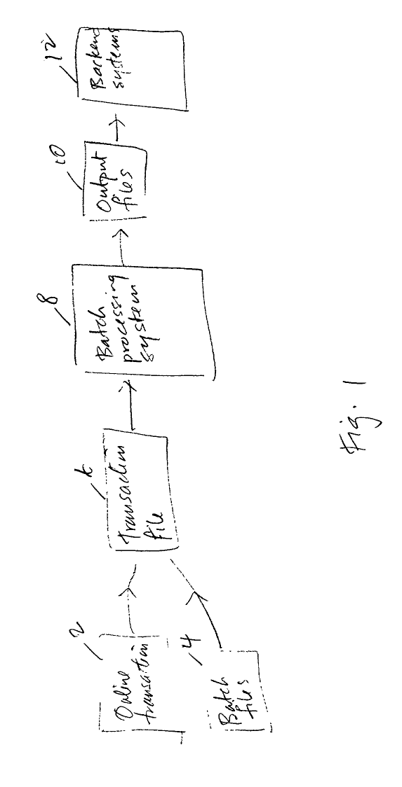

FIG. 2 is a flow diagram illustrating the operations of an exemplary embodiment of the present invention.

### DETAILED DESCRIPTION OF THE INVENTION

The present invention in the form of one or more exemplary embodiments will now be described. An exemplary embodiment of the present invention is implemented as part of a computer system or infrastructure, such as the one described in U.S. Provisional Patent Application Serial No. [to be assigned], entitled “METHOD AND SYSTEM FOR PROCESSING CREDIT CARD RELATED TRANSACTIONS,” by Zelechoski et al., filed on Mar. 4, 2002, and commonly assigned and owned, the disclosure of which is hereby incorporated by reference in its entirety as if fully set forth herein for all purposes. Based on the disclosure and teaching provided herein, a person of ordinary skill in the art would know of other ways and/or methods to implement the present invention.

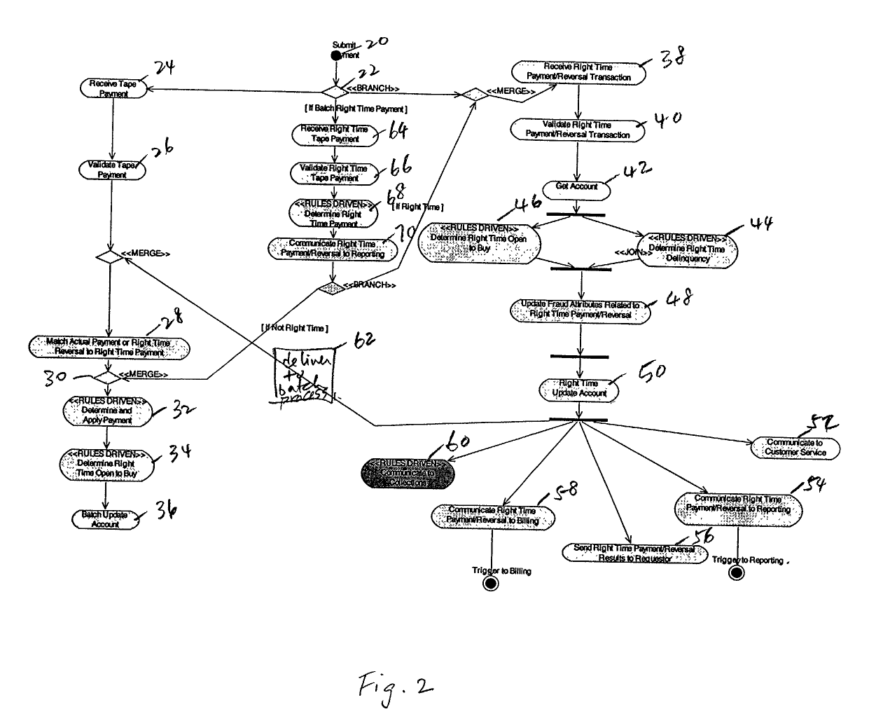

FIG. 2 is a flow diagram illustrating the operations of an exemplary embodiment of the present invention. Prior to engaging step 20, payments are received by a client or user from account holders. Many different types of vehicles can be used to make a payment on a credit account including, for example, check, money order, cash, credit card, debit card, electronic fund transfer, wire transfer, coupon, etc. In addition, payments can be received from a number of different sources, such as, a teller, an ATM, a retailer, online banking and mail. The payments are first processed by the client or user. Relevant information for each payment is captured and put into the proper format in the form of a payment transaction. The payment transaction further includes other information relating to the client. A payment transaction created by the client or user is not limited to a payment received for an amount owed on a credit account but also includes any type of monetary transaction which may have an impact on the available credit or open-to-buy amount relating to that credit account. For example, a payment transaction can be generated by the client to represent a reversal reversing a previously paid amount that is erroneous.

It should be understood that, for illustrative purposes, while the operations of the exemplary embodiment is described with respect to an individual payment transaction submitted by a client, the present invention is similarly applicable to processing multiple payment transactions submitted by a number of different clients. Referring to FIG. 2, at 20, a payment transaction to be applied to the corresponding credit account is submitted by the client or user. A payment transaction can be submitted by the client or user in one of three ways. More specifically, the payment transaction can be submitted electronically or via one of two different types of tapes or other storage media. As described above, the client or user extracts the relevant information for each payment submitted by an account holder and incorporates such information into the proper format in a payment transaction. Such format includes, for example, an electronic format and two different types of tape formats. As will be more fully described below, depending on how the payment transaction is submitted by the client, either a right-time process or a batch process is invoked to process the payment transaction. At 22, the payment transaction submission method is verified to determine which process should be invoked to process the payment transaction.

A payment transaction submitted via a batch tape is referred to as a batch payment transaction. The batch process is invoked at a specific time to process the batch payment transactions contained in the batch tape. Typically, the batch process is initiated to process the batch tape at a designated time each day. Upon initiation, the batch process operates as follows. At 24, the batch payment transaction is received or read from the batch tape. At 26, the batch payment transaction is validated to ensure that the batch payment transaction can be processed. At 28, the batch payment transaction is matched up with a right-time payment transaction, if any. As will be further explained below, processed right-time payment transactions are delivered to the batch process. This step is performed to ensure that duplicate entries are not processed against the same credit account. It should be understood that in an alternative exemplary embodiment, this step may not be performed depending on how batch payment transactions and right-time payment transactions are organized and submitted. For example, if the batch payment transactions and the right-time payment transactions are mutually exclusive of each other, then this step 28 need not be performed. After 28, at 30, payment transactions from a right-time tape are inserted into the batch process for processing. The insertion of payment transactions from the right-time tape will be further described below. At 32, the batch payment transaction is applied against the corresponding credit account. For example, the payment amount can be divided and applied to various portions of the account balance. At 34, the available credit or open-to-buy amount is adjusted based on the applied payment amount of the batch payment transaction. The payment amount of the batch payment transaction to be applied to the available credit varies depending on a number of factors, such as, the attributes or conditions of the credit account. For example, if the credit account has a history of bounced check payments and the payment amount is made in check, then the available credit may not be adjusted until the check is cleared. On the other hand, if the payment amount was made in cash, then the full payment amount may be applied to the available credit. In another example, the amount of available credit to be adjusted is determined by an external system in order to minimize fraud. At 36, the corresponding credit account is updated.

If the payment transaction is submitted via either the right-time tape or the electronic format, then the right-time process is invoked to process the payment transaction in real-time. A payment transaction submitted and processed in the foregoing manner is referred to as a right-time payment transaction. The right-time process differs from the batch process in that the right-time process is invoked immediately or as soon as practicable upon receipt of a right-time payment transaction.

A right-time payment transaction can be submitted electronically. For example, a client or user may submit right-time payment transactions for processing via a computer network, such as the Internet, or a dedicated communication link, such as a T1 trunk. At 38 a right-time payment transaction is received and verified to insure that the right-time payment transaction is in the proper format.

At 40 the right-time payment transaction is validated to ensure that the right-time payment transaction can be processed. As part of this validation process, a number of validation checks are performed. For example, if a right-time payment transaction relates to a reversal, i.e., a previously made payment is to be retracted, then a match is performed in an attempt to match this right-time payment transaction against the previous right-time payment transaction relating to the previously made payment. If no match is found, the right-time payment transaction is declined and not processed. In addition, the right-time payment transaction is checked to make sure that the client who submitted the right-time payment transaction is authorized to conduct activities relative to the credit account identified by the right-time payment transaction. Moreover, the right-time payment transaction is also checked to ensure that the client number, the credit account number and the payment amount are valid. It should be understood that, in addition to the foregoing, other validation checks may also be performed.

At 42, the corresponding credit account (and the associated information) for that right-time payment transaction is retrieved. Then, using the retrieved information, the status of the credit account is evaluated to determine how the right-time payment transaction is to be applied.

At 44, the delinquency status of the credit account is determined. If the credit account is currently delinquent, then the right-time payment transaction is applied to the delinquent amount. If the right-time payment transaction relates to a payment, then the delinquent amount is decremented by the payment amount. If the payment amount is greater than or equal to the delinquent amount, then the delinquent status is changed to reflect that the credit account is no longer delinquent and the number of days delinquent is adjusted to zero. On the other hand, if the right-time payment transaction relates to a reversal (at this point, this right-time payment transaction matches up with a previous right-time payment transaction because it passed the validation check) and the previous right-time payment transaction brought the credit account out of delinquency, then the delinquency status, the delinquency amount and the number of days delinquent are restored to their respective values prior to the previous right-time payment transaction. In other words, the credit account is rendered delinquent due to reversal or retraction of the previously made payment.

At 46, the right-time payment transaction is applied to the available credit or open-to-buy amount. The available credit is adjusted upward or downward based on whether the right-time payment transaction relates to a payment or a reversal. When applying the right-time payment transaction to the available credit, the available credit will not be increased beyond a preset credit line assigned to that credit account. Furthermore, as mentioned above, the payment amount of the right-time payment transaction to be applied to the available credit varies depending on a number of factors, such as, the attributes or conditions of the credit account. For example, if the credit account has a history of bounced check payments and the payment amount is made in check, then the available credit may not be adjusted until the check is cleared. On the other hand, if the payment amount was made in cash, then the full payment amount may be applied to the available credit. Similarly, based on evaluation of the factors, portions of the payment amount may be applied to the available credit accordingly.

At 48, fraud attributes relating to the right-time payment transaction are updated. For example, one of the attributes that is updated reflects the number of days since the last payment was applied to the credit account. If the right-time payment transaction relates to a payment, this attribute is reset to zero to reflect the payment that has just been made. Another attribute that is updated reflects the aggregate amount of payments that were made within a preceding period, for example, the last 30 days. If the right-time payment transaction relates to a payment, this attribute is incremented to include the payment amount identified in the right-time payment transaction. On the other hand, if the right-time payment transaction relates to a reversal, this attribute is decremented accordingly. Optionally, these updated fraud attributes can be supplied to a computerized system, such as, a system called “Falcon” sold by HNC, or other commercially available systems, to allow account activities to be analyzed in a more timely manner for purposes of detecting and preventing fraud.

At 50, the corresponding credit account is updated. After the credit account is updated, a number of other functions are also performed by the right-time process. Optionally, these other functions can be performed in either a serial or a parallel manner. For example, at 52, the updated account information pertaining to the updated credit account is communicated to customer service which is usually made available customer service representatives via customer service screens. By providing this updated information to customer service, customer service representatives may then, in turn, convey the latest account information to the cardholder in the event of an inquiry.

At 54, information relating to the processed right-time payment transaction is delivered to a reporting function which compiles information and reports relating to all the processed right-time payment transactions.

At 56, the information relating to the processed right-time payment transaction is also delivered to the client or user who submitted the right-time payment transaction for processing to notify the client of the result of the processed right-time payment transaction. For example, the client is informed of a right-time payment transaction that has been rejected due to a failed validation check or a right-time payment transaction relating to a reversal that has been rejected due to non-existence of a matching previous right-time payment transaction.

At 58, the information relating to the processed right-time payment transaction is communicated to a billing function which keeps track of the number of processed righttime payment transactions for the client or user for billing purposes.

At 60, the updated account information pertaining to the updated credit account is also communicated to collections. The updated account information may be provided in the form of an action entry, a collection memo or an external collection source file which is specific to the client submitting the right-time payment transaction. The external collection source file may include fields, such as, account number, date, amount, i payment source, payment type, input source, time and transaction type. Optionally, the updated account information can be fed to a computerized collections system whose primary function is to initiate and coordinate collections actions. Such computerized collections system may be custom developed or provided by a commercial vendor. By providing this updated information to collections, collection agents may then more appropriately adjust their plan of action relating to the corresponding credit account. For example, armed with the latest account information, a collection agent may call the cardholder to thank the cardholder for his/her payment as opposed to demanding payment which had already been made.

Furthermore, after the corresponding credit account is updated, at 62, the pertinent information is delivered to the batch process for reconciliation to eliminate duplicate entries made against the same credit account. As mentioned above, this step is optional depending on how the batch payment transactions and the right-time payment transactions are organized.

As mentioned above, the right-time payment transaction can also be submitted via a right-time tape. The right-time tape differs from the batch tape in that the right-time tape is processed immediately or as soon as practicable upon submission. At 64, a right-time payment transaction from the right-time tape is received. At 66, the right-time payment transaction is validated to ensured that this right-time payment transaction can be processed. At 68, the right-time payment transaction is checked to determine whether the right-time process should be initiated to process this right-time payment transaction. It should be noted that, in some instances, only some (or none) of the payment transactions contained on the right-time tape may need to be processed by the right-time process. In other words, the right-time payment transactions which are to be processed are selectively extracted from the right-time tape. Hence, the client can selectively designate which of the payment transactions, if any, on the right-time tape are to be processed by the right-time process. At 70, information relating to the extracted right-time payment transactions is communicated to a reporting function which, amongst other things, complies and reports information relating to the extracted right-time payment transactions. The extracted right-time payment transactions are then put into the appropriate format and delivered to the right-time process for processing at 38, as described above. Since the right-time tape may contain payment transactions which are not designated for processing by the right-time process, these payment transactions (since they have already been validated) can now be inserted into the batch process, at 30 as previously mentioned, to await processing.

It should be understood that while the above is described with respect to an individual credit account, it will be appreciated by a person of ordinary skill in the art that the present invention can be applied to relationship credit accounts, such as, family member accounts and corporate accounts, and that the present invention can also be applied to other types of accounts.

It should also be understood that the present invention may be implemented in the form of control logic using software, hardware, or a combination of both, in a modular or integrated manner. The present invention can be implemented as a stand-alone system or as part of a larger computer system. Based on the disclosure provided herein, a person of ordinary skill in the art will know of other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for processing account payments, comprising:
control logic configured to receive one or more payment transactions from a client;
control logic configured to determine how each of the payment transactions is to be processed;
control logic configured to invoke a real-time process to process payment transactions that are determined to be processed on a real-time basis, the real-time process being invoked upon submission of the payment transactions that are determined to be processed on the real-time basis; and
control logic configured to invoke a batch process to process payment transactions that are determined to be processed on a batch basis, the batch process being invoked at a designated time in a processing cycle without regard to timing of submission of the payment transactions that are determined to be processed on the batch basis;
wherein for each payment transaction processed by the real-time process, available credit relative to a corresponding account is adjusted in real-time based on information included in such payment transaction.

2. The system according to claim 1 wherein upon adjusting the available credit relative to the corresponding account in real-time, the available credit is immediately accessible to an account holder of the corresponding account.

3. The system according to claim 1 wherein a payment transaction represents either a payment to be credited against a corresponding account or a reversal to be performed against the corresponding account to retract a previously made payment.

4. The system according to claim 3 wherein for each transaction payment processed by the real-time process, if such payment transaction represents a payment to be credited against the corresponding account, a payment amount identified in such payment transaction is applied in whole or in part to the available credit relative to the corresponding account in real-time in accordance with evaluation results derived from evaluating one or more attributes relating to the corresponding account.

5. The system according to claim 3 wherein for each payment transaction processed by the real-time process, delinquency status relative to the corresponding account is updated in real-time based on information included in such payment transaction.

6. The system according to claim 5 wherein for each payment transaction processed by the real-time process, if such payment transaction represents a reversal to be performed against the corresponding account to retract the previously made payment, the delinquency status is restored to its value prior to the previously made payment.

7. The system according to claim 5 wherein for each payment transaction processed by the real-time process, if such payment transaction represents a payment to be credited against the corresponding account and a payment amount identified in such payment transaction exceeds or equals to a delinquent amount relative to the corresponding account, the delinquency status is updated to non-delinquent in real-time.

8. The system according to claim 1 further comprising:
control logic configured to update in real-time one or more fraud attributes relating to the corresponding account for each payment transaction processed by the real-time process based on information included in the payment transaction.

9. The system according to claim 8 wherein the one or more fraud attributes are forwarded to a fraud prevention system to allow more timely monitoring of potential fraudulent activities concerning the corresponding account.

10. The system according to claim 1 further comprising:
control logic configured to forward information relating to each payment transaction processed by the real-time process including the available credit relative to the corresponding account to customer service.

11. The system according to claim 1 further comprising:
control logic configured to forward information relating to each payment transaction processed by the real-time process including the available credit relative to the corresponding account to collections.

12. The system according to claim 1 further comprising:
control logic configured to inform the client about status of the payment transactions processed by the real-time process.

13. The system according to claim 1 wherein the corresponding account is a credit card account.

14. The system according to claim 1 wherein the system is implemented in software, hardware or a combination of both.

15. A system for processing account payments, comprising:
control logic configured to receive a plurality of payment transactions from a plurality of sources including a first source, a second source and a third source;
control logic configured to invoke a batch process to process one or more of the plurality of payment transactions received from the first source on a batch basis;
control logic configured to invoke a real-time process to process one or more of the plurality of payment transactions received from the second source on a real-time basis;
control logic configured to invoke an extracting process to process one or more of the plurality of payment transactions received from the third source, the one or more of the plurality of payment transactions processed by the extracting process being further processed by either the batch process or the real-time process;
wherein for each payment transaction processed by the real-time process, available credit relative to a corresponding account is adjusted in real-time based on information included in such payment transaction; and
wherein the batch process is invoked at a designated time in a processing cycle without regard to timing of receipt of payment transactions from the first source or the extracting process and the real-time process is invoked upon receipt of payment transactions from the second source or the extracting process.

16. The system according to claim 15 wherein the first source is a tape having payment transactions to be processed by the batch process.

17. The system according to claim 15 wherein the second source is an electronic file having payment transactions to be processed by the real-time process.

18. The system according to claim 15 wherein the third source is a tape having payment transactions to be processed by either the batch process or the real-time process.

19. The system according to claim 15 wherein the extracting process separates the payment transactions received from the third source based on whether a payment transaction is to be processed by the batch process or the real-time process; and
wherein the separated payment transactions are respectively submitted to the batch process and the real-time process for further processing.

20. The system according to claim 15 wherein upon adjusting the available credit relative to the corresponding account in real-time, the available credit is immediately accessible to an account holder of the corresponding account.

21. The system according to claim 15 wherein a payment transaction represents either a payment to be credited against a corresponding account or a reversal to be performed against the corresponding account to retract a previously made payment.

22. The system according to claim 21 wherein for each transaction payment processed by the real-time process, if such payment transaction represents a payment to be credited against the corresponding account, a payment amount identified in such payment transaction is applied in whole or in part to the available credit relative to the corresponding account in real-time in accordance with evaluation results derived from evaluating one or more attributes relating to the corresponding account.

23. The system according to claim 21 wherein for each payment transaction processed by the real-time process, delinquency status relative to the corresponding account is updated in real-time based on information included in such payment transaction.

24. The system according to claim 23 wherein for each payment transaction processed by the real-time process, if such payment transaction represents a reversal to be performed against the corresponding account to retract the previously made payment, the delinquency status is restored to its value prior to the previously made payment.

25. The system according to claim 23 wherein for each payment transaction processed by the real-time process, if such payment transaction represents a payment to be credited against the corresponding account and a payment amount identified in such payment transaction exceeds or equals to a delinquent amount relative to the corresponding account, the delinquency status is updated to non-delinquent in real-time.

26. The system according to claim 15 further comprising:
control logic configured to update in real-time one or more fraud attributes relating to the corresponding account for each payment transaction processed by the real-time process based on information included in the payment transaction.

27. The system according to claim 26 wherein the one or more fraud attributes are forwarded to a fraud prevention system to allow more timely monitoring of potential fraudulent activities concerning the corresponding account.

28. The system according to claim 15 further comprising:
control logic configured to forward information relating to each payment transaction processed by the real-time process including the available credit relative to the corresponding account to customer service.

29. The system according to claim 15 further comprising:
control logic configured to forward information relating to each payment transaction processed by the real-time process including the available credit relative to the corresponding account to collections.

30. The system according to claim 15 further comprising:
control logic configured to inform the client about status of the payment transactions processed by the real-time process.

31. The system according to claim 15 wherein the corresponding account is a credit card account.

32. The system according to claim 15 wherein the system is implemented in software, hardware or a combination of both.

33. A method for processing account payments, comprising:
receiving a plurality of payment transactions from a client;
determining how each of the plurality of payment transactions is to be processed;
upon submission of payment transactions that are determined to be processed on a real-time basis, invoking a real-time process to process such payment transactions;
invoking a batch process at a designated time in a processing cycle to process payment transactions that are determined to be processed on a batch basis; and
for each payment transaction processed by the real-time process, adjusting available credit relative to a corresponding account in real-time based on information included in such payment transaction.

34. The method of claim 33 further comprising:
upon adjusting the available credit relative to the corresponding account in real-time, rendering the available credit to be immediately accessible to an account holder of the corresponding account.

35. The method of claim 33 wherein a payment transaction represents either a payment to be credited against a corresponding account or a reversal to be performed against the corresponding account to retract a previously made payment.

36. The method of claim 35 further comprising:
for each payment transaction processed by the real-time process, if such payment transaction represents a payment to be credited against the corresponding account, applying a payment amount identified in such payment transaction in whole or in part to the available credit relative to the corresponding account in real-time in accordance with evaluation results derived from evaluating one or more attributes relating to the corresponding account.

37. The method of claim 35 further comprising:
for each payment transaction processed by the real-time process, updating a delinquency status relative to the corresponding account in real-time based on information included in such payment transaction.

38. The method of claim 37 further comprising:
for each payment transaction processed by the real-time process, if such payment transaction represents a reversal to be performed against the corresponding account to retract the previously made payment, restoring the delinquency status to its value prior to the previously made payment.

39. The method of claim 37 further comprising:
for each payment transaction processed by the real-time process, if such payment transaction represents a payment to be credited against the corresponding account and a payment amount identified in such payment transaction exceeds or equals to a delinquent amount relative to the corresponding account, updating the delinquency status to non-delinquent in real-time.

40. The method of claim 33 further comprising:
updating in real-time one or more fraud attributes relating to the corresponding account for each payment transaction processed by the real-time process based on information included in the payment transaction.

41. The method of claim 40 further comprising:
forwarding the one or more fraud attributes to a fraud prevention system to allow more timely monitoring of potential fraudulent activities concerning the corresponding account.

42. The method of claim 33 further comprising:
forwarding information relating to each payment transaction processed by the real-time process including the available credit relative to the corresponding account to customer service.

43. The method of claim 33 further comprising:
forwarding information relating to each payment transaction processed by the real-time process including the available credit relative to the corresponding account to collections.

44. The method of claim 33 wherein the corresponding account is a credit card account.

45. The method of claim 33 wherein the method is implemented in software, hardware or a combination of both.

46. A method for processing credit card payments, comprising:
receiving a plurality of payment transactions from a plurality of sources including a first source, a second source and a third source;
invoking a batch process at a designated time in a processing cycle to process payment transactions received from the first source on a batch basis;
upon receiving payment transactions from the second source, invoking a real-time process to process the payment transactions received from the second source on a real-time basis;
upon receiving payment transactions from the third source, invoking an extracting process to process payment transactions received from the third source, wherein payment transactions processed by the extracting process are fed to either the batch process or the real-time process or both;
upon receiving the payment transactions processed by the extracting process, invoking the real-time process to process the payment transactions received from the extracting process on a real-time basis; and
for each payment transaction processed by the real-time process, adjusting available credit relative to a corresponding account in real-time based on information included in such payment transaction.

47. The method of claim 46 wherein the first source is a tape having payment transactions to be processed by the batch process.

48. The method of claim 46 wherein the second source is an electronic file having payment transactions to be processed by the real-time process.

49. The method of claim 46 wherein the third source is a tape having payment transactions to be processed by either the batch process or the real-time process.

50. The method of claim 46 wherein the extracting process separates the payment transactions received from the third source based on whether a payment transaction is to be processed by the batch process or the real-time process; and
wherein the separated payment transactions are respectively submitted to the batch process and the real-time process for further processing.

51. The method of claim 46 further comprising:
upon adjusting the available credit relative to the corresponding account in real-time, rendering the available credit to be immediately accessible to an account holder of the corresponding account.

52. The method of claim 46 wherein a payment transaction represents either a payment to be credited against a corresponding account or a reversal to be performed against the corresponding account to retract a previously made payment.

53. The method of claim 52 further comprising:
for each transaction payment processed by the real-time process, if such payment transaction represents a payment to be credited against the corresponding account, applying a payment amount identified in such payment transaction in whole or in part to the available credit relative to the corresponding account in real-time in accordance with evaluation results derived from evaluating one or more attributes relating to the corresponding account.

54. The method of claim 52 further comprising:
for each payment transaction processed by the real-time process, updating a delinquency status relative to the corresponding account in real-time based on information included in such payment transaction.

55. The method of claim 54 further comprising:
for each payment transaction processed by the real-time process, if such payment transaction represents a reversal to be performed against the corresponding account to retract the previously made payment, restoring the delinquency status to its value prior to the previously made payment.

56. The method of claim 54 further comprising:
for each payment transaction processed by the real-time process, if such payment transaction represents a payment to be credited against the corresponding account and a payment amount identified in such payment transaction exceeds or equals to a delinquent amount relative to the corresponding account, updating the delinquency status to non-delinquent in real-time.

57. The method of claim 46 further comprising:
updating in real-time one or more fraud attributes relating to the corresponding account for each payment transaction processed by the real-time process based on information included in the payment transaction.

58. The method of claim 57 further comprising:
forwarding the one or more fraud attributes to a fraud prevention system to allow more timely monitoring of potential fraudulent activities concerning the corresponding account.

59. The method of claim 46 further comprising:
forwarding information relating to each payment transaction processed by the real-time process including the available credit relative to the corresponding account to customer service.

60. The method of claim 46 further comprising:
forwarding information relating to each payment transaction processed by the real-time process including the available credit relative to the corresponding account to collections.

61. The method of claim 46 further comprising:
informing the client about status of the payment transactions processed by the real-time process.

62. The method of claim 46 wherein the corresponding account is a credit card account.

63. The method of claim 46 wherein the method is implemented in software, hardware or a combination of both.
